(19) United States
(12) Patent Application Publication
(10) Pub. No.: US 2005/0247076 A1
(43) Pub. Date: Nov. 10, 2005

(54) Water cooler bottle and dispenser cover

(76) Inventor: Michael Luna, Lodi, NJ (US)

Correspondence Address: KALIKO & YEAGER, L.L.C., 500 NORTH FRANKLIN TURNPIKE, RAMSEY, NJ, 07446, US

(21) Appl. No.: 10/838,757

(22) Filed: May 4, 2004

(51) Int. Cl. F25D 17/06; B67D 5/62

(52) U.S. Cl. 62/389

(57) ABSTRACT

A free standing water cooler bottle and dispenser cover that may include an upper housing, a middle housing, and a lower housing (optionally the upper, middle, lower housings may be combined into a single housing). Where the housings are defined by a top section, a front section, optionally a rear section, and two side sections. The dimensions of the housings are capable of accepting and covering a water cooler bottle and dispenser. The housings may include at least one water outlet means, at least one storage and/or shelf means, a plurality of retractable wheels, and a wheel engagement/locking means.

### BACKGROUND OF THE INVENTION

This invention relates to a water cooler bottle and dispenser covering device. More particularly, this invention relates to a rigid, free standing device that covers all or at least three sides of the exterior of a water cooler bottle and dispenser and also functions as a piece of furniture.

Covers for water cooler bottles are well known. However, the prior art fails to address the disadvantages associated with the use of water cooler dispensers. One such disadvantage is that water coolers dispensers generally take up a significant amount of space and this space often cannot be utilized for any other purpose.

Another drawback with the use of conventional water cooler dispensers is that they have an unsightly appearance and are often placed in remote locations of a home or office. Placement of the water cooler in such a remote location often leads to a lack of use.

It therefore would be desirable to provide a free standing water cooler bottle and dispenser cover with added aesthetics that may be utilized as a piece of furniture.

### SUMMARY OF THE INVENTION

An object of the present invention is to provide a free standing water cooler bottle and dispenser cover with added aesthetics that may function as a piece of furniture.

In accordance with this invention an apparatus for covering a water cooler bottle and dispenser is provided. The water cooler bottle and dispenser may include an upper housing defined by a top section, a front section, optionally a rear section, and two side sections. The dimensions of the upper housing are capable of accepting and covering a water cooler bottle. The cover may also include a middle housing defined by a front section, optionally a rear section, and two side sections. The dimensions of the middle housing are capable of accepting and covering a water cooler dispenser. The middle housing may include at least one water outlet means and at least one storage and/or display means. The middle housing may further include a plurality of retractable wheels and a wheel engagement means. The upper housing may be detachably connected to the middle housing.

Another embodiment may include a lower housing defined by a porous top section that may allow spilled water to pass through to a water retention tray, a removable front section that provides access to spilled water, a rear section, and a bottom section. The lower housing may further include a plurality of retractable wheels and a wheel engagement means. The lower housing may be detachably connected to the middle housing.

Another embodiment of the present invention may include a ventilation means to allow heat and moisture to escape from the air space between the water cooler bottle and dispenser and the top, the middle, and/or the lower housing.

The above and other objects, features, and advantages of the present invention will become apparent upon consideration of the following detailed description, taken in conjunction with the accompanying drawings in which like reference characters refer to like parts throughout.

### BRIEF DESCRIPTION OF THE DRAWINGS

FIG. 1 shows a front perspective view of an embodiment of a water cooler bottle and dispenser cover that may be used for performing the present invention.

FIG. 2 shows a rear view of an embodiment of a water cooler bottle and dispenser cover that may be used for performing the present invention.

FIG. 3 shows a front perspective view of an embodiment of a water cooler bottle and dispenser cover that may be used for performing the present invention.

FIG. 4 shows an exploded front view of an embodiment of a water cooler bottle and dispenser cover that may be used for performing the present invention.

FIG. 5 shows a rear view of an embodiment of a water cooler bottle and dispenser cover that may be used for performing the present invention.

### DETAILED DESCRIPTION OF THE PREFERRED EMBODIMENTS

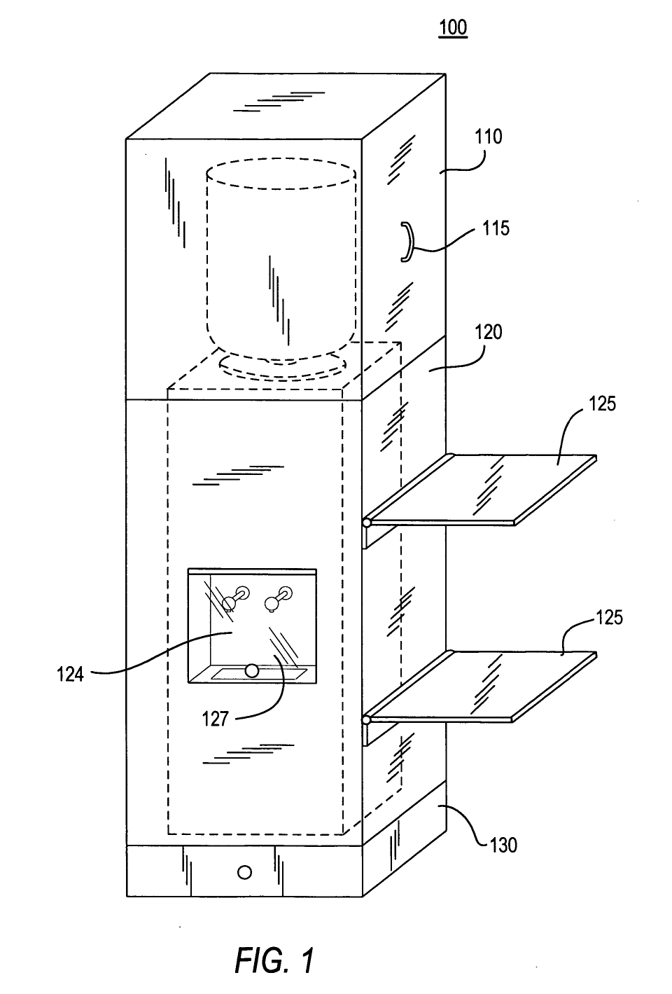

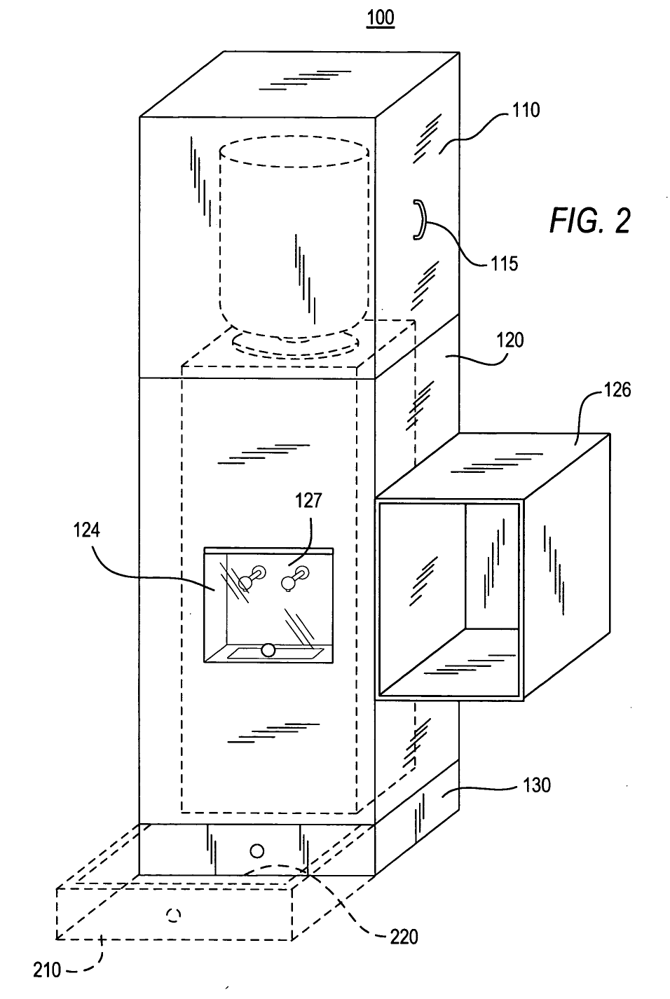

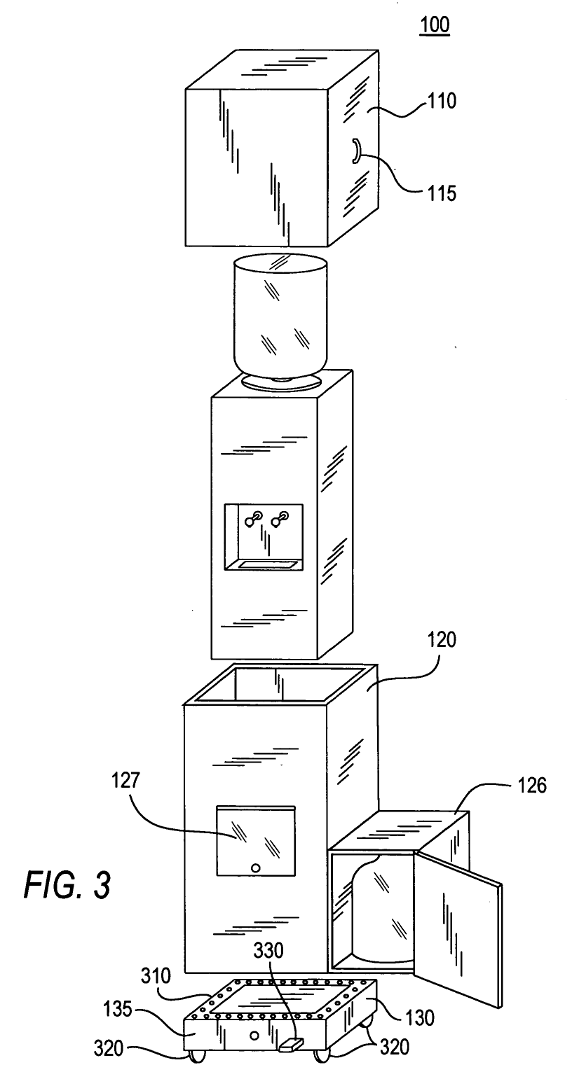

FIGS. 1-3 show a front view of three preferred embodiments of an apparatus 100 according to the invention. Apparatus 100 may include upper housing 110, upper housing handle means 115, middle housing 120, shelf means 125 (as shown in FIG. 1), storage means 126 (as shown in FIGS. 2 and 3), water outlet means 124, nozzle cover 127, lower housing 130, removable front cover 210, water retention tray 220, porous section 310, retractable wheels 320, and wheel engagement/locking means 330.

As shown in FIGS. 1-4, upper housing 110 may be used to cover a water bottle and may be removably attached to middle housing 120. Middle housing 120 may be used to cover a water cooler dispenser. When upper housing 110 is attached to middle housing 120 the front, back, and side surfaces of upper housing 110 may be parallel to and lie within the same plane as the corresponding front, back, and side surfaces of middle housing 120, thus creating a smooth transition between upper housing 110 and middle housing 120. In one embodiment, upper housing 110 may be attached to middle housing 120 using a tongue and groove arrangement (not shown). In another embodiment, upper housing 110 may be attached to middle housing 120 using a fastening clip arrangement (not shown) spaced periodically about the perimeter of the bottom portion of upper housing 110 and about the top portion of middle housing 120, and/or using any other suitable attachment arrangement.

One embodiment of upper housing 110 may include a hinged front face and a hinged top face (not shown). The front face and the top face of upper housing 110 may be hinged in such manner as to allow easy access to, removal, and replacement of the water cooler's water bottle. For example, the top side of upper housing 110 may be hinged to the rear of the device such that the top of the device may be opened from the front and opened angularly (between 0 degrees and approximately 180 degrees) toward the rear of the device.

Another embodiment of the present invention may include at least one shelf means 125 (as shown in FIGS. 1, 4 and 5) and/or at least one storage means 126 (as shown in FIGS. 2 and 3). Shelf means 125 may be fixably, removably, or rotatably attached to middle housing 120, and storage means 126 may be fixably or removably attached to middle housing 120. When shelf means 125 and/or storage means 126 are used in accordance with the present invention, they may be attached to middle housing 120 in such a manner as to support the objects. For example, shelf means 125 or storage means 126 may be attached to middle housing 120 in such a manner to support one or more books, one or more plants, one or more picture frames, a water cooler bottle, or the like.

FIG. 1 also shows that middle housing 120 may further include water outlet means 124. Water outlet means 124 may be an opening located on or within a face of middle housing 120 to provide access to a water cooler dispenser's water dispensing nozzles. Water outlet means 124 may be concealed by nozzle cover 127. Nozzle cover 127 may be ornamental in design and may open horizontally or vertically or may provide access to a water cooler's water dispensing nozzles by using one or more sliding or hinged doors located on or within the face of middle housing 120.

As shown in FIGS. 1-4, apparatus 100 may further include lower housing 130. Lower housing 130 may be used as a base for the water cooler dispenser and may be removably attached to middle housing 120. When lower housing 130 is attached to middle housing 120 the front, back, and side surfaces of lower housing 130 may be parallel to and lie within the same plane as the corresponding front, back, and side surfaces of middle housing 120, thus creating a smooth transition between middle housing 120 and lower housing 130. In one embodiment, lower housing 130 may be attached to middle housing 120 using a tongue and groove arrangement (not shown). In another embodiment, lower housing 130 may be attached to middle housing 120 using a fastening clip arrangement (not shown) spaced periodically about the perimeter of the bottom portion of middle housing 120 and about the top portion of lower housing 130, and/or using any other suitable attachment arrangement.

As shown in FIG. 2, lower housing 130 may further include removable front cover 210. When removed, removable front cover 210 may provide access to water retention tray 220. Water retention tray 220 may be a water-resistant or waterproof water collection tray that is designed to temporarily collect and store spilled water that may accumulate during use of the water cooler dispenser. For example, water retention tray 220 may be a rubber-lined or other suitable silicone or polymer-lined tray capable of temporarily holding and/or storing relatively small amounts of spilled or condensed water.

As shown in FIG. 3, lower housing 130 may further include porous section 310, retractable wheels 320, and wheel engagement/locking means 330. Porous section 310 may be located on the top side of lower housing 130. Porous section 310 may be holes or any other suitable shapes or perforation located through the top side of lower housing 130. For example, the holes located through the top side of lower housing 130 may allow spilled and/or condensed water to pass through lower housing 130 and collect within the above-described water retention tray 220.

As mentioned above, lower housing 130 may include a plurality of retractable wheels 320. Retractable wheels 320 may be wheels that are hinged, spring-loaded, or otherwise suitably attached to lower housing 130 in such a manner that when wheels 320 are engage they become the supporting element of apparatus 100, and when wheels 320 are not in use they are in a retracted or folded position such that the bottom side of lower housing 130 is the supporting element of apparatus 100.

Lower housing 130 may also include wheel engagement/locking means 330. Wheel engagement/locking means 330 may be used to engage or disengage retractable wheels 320. For example, wheel engagement/locking means may be a two stage foot pedal that is mechanically attached to retractable wheels 320 such that when a first force is applied to the foot pedal retractable wheels 320 becomes engaged and when a second force is applied to the foot pedal, retractable wheels 320 become disengaged.

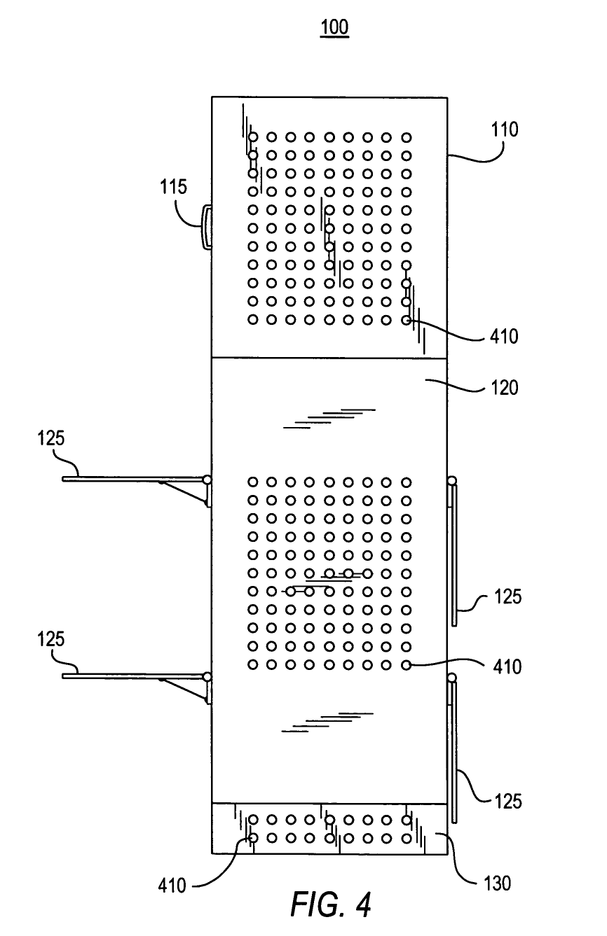

Now referring to FIG. 4, apparatus 100 may include ventilation means 410. Ventilation means 410 may allow heat and moisture that may accumulate in the operation of the water cooler to escape from the air space between the water cooler bottle and dispenser and the top, middle, and/or lower housing. For example, ventilation means 410 may be perforations, holes, or other suitable shapes located through the rear side of apparatus 100 that may allow heat and moisture to escape from the airspace located between the apparatus 100 and the water cooler. Although not shown, ventilation means 410 may be located on any suitable side of apparatus 100.

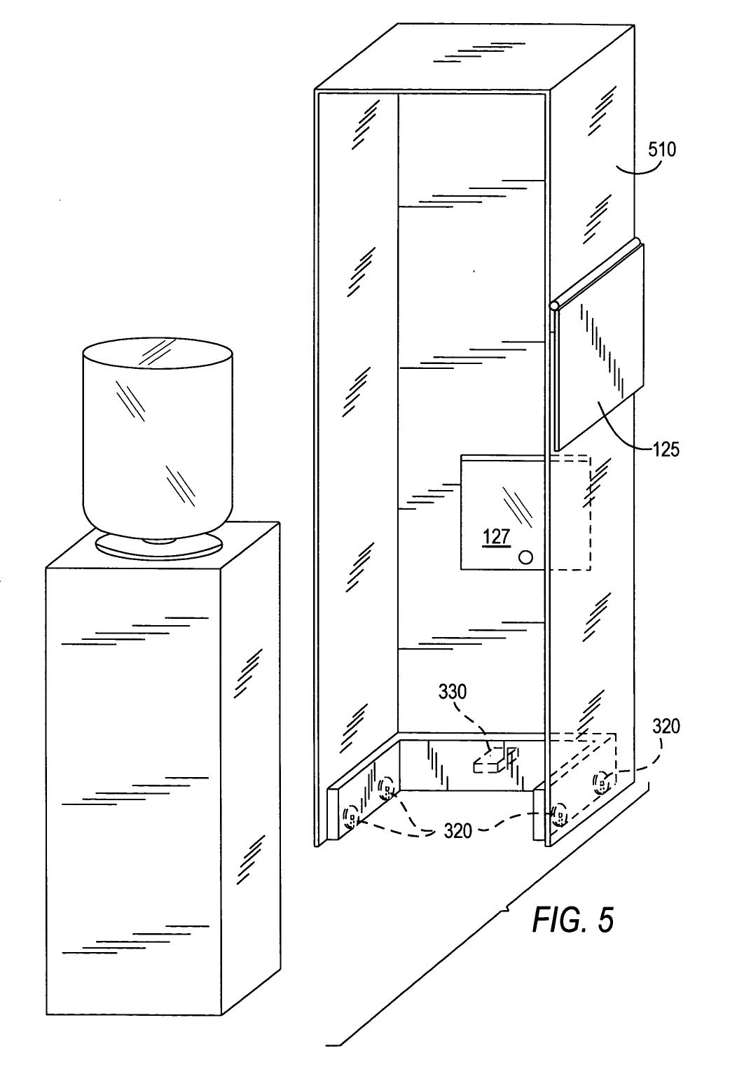

In another embodiment, as shown in FIG. 5, upper housing 110, middle housing 120, and lower housing 130 may be combined into single housing 510. Single housing 510 may provide all or some of the features described above.

Construction materials of the present invention may include wood, laminates, molded rigid plastics, or any other suitable material that may support the above-described structures and additional weighted elements (e.g., one or more picture frames, one or more plants, a water cooler bottle, etc.).

Thus, an aesthetically pleasing, rigid free standing device for covering a water cooler bottle and dispenser that functions as a piece of furniture is provided. Persons skilled in the art will appreciate that the described embodiments are presented for the purpose of illustration rather than limitation and the that present invention is limited only by the claims that follow.

1. A free standing water cooler bottle and dispenser cover comprising:
an upper housing defined by a top section, a front section, a rear section, and two side sections, wherein the dimensions of the upper housing are at least capable of accepting and covering a water cooler bottle;
a middle housing defined by a front section, a rear section, and two side sections, wherein the dimensions of the middle housing are at least capable of accepting and covering a water cooler dispenser, and wherein the middle housing includes at least one water outlet means; and
wherein the upper housing is detachably connected to the middle housing.

2. The apparatus of claim 1 further comprising a lower housing defined by:
a water-resistant tray capable of collecting water;
a porous top section that allows water to pass through to the water retention tray;
two side sections, a rear section, and a bottom section;
a removable front section to provide access to the water retention tray;
a plurality of retractable wheels;
a wheel engagement/locking means; and
wherein the lower housing is detachably connected to the middle housing.

4. The apparatus of claim 1, further comprising one or more handle means attached to the upper housing to assist in the removal of upper housing from the middle housing.

5. The apparatus of claim 1, further comprising at least one of a storage and a shelf means attached to the middle housing.

6. The apparatus of claim 5, wherein the shelf means is rotatably attached to the middle housing.

8. The apparatus of claim 5, wherein the shelf means is fixably attached to the middle housing.

9. The apparatus of claim 1, wherein the upper housing and the middle housing are constructed of wood.

10. The apparatus of claim 2, wherein the lower housing is constructed of wood.

11. The apparatus of claim 1, wherein the upper housing and the middle housing are constructed of a laminate.

12. The apparatus of claim 2, wherein the lower housing is constructed of a laminate.

13. The apparatus of claim 1, wherein the upper housing and the middle housing are constructed of a molded rigid plastic.

14. The apparatus of claim 1, wherein the lower housing is constructed of a molded rigid plastic.

15. The apparatus of claim 1, further comprising a ventilation means to allow heat and moisture to escape from the air space between the cover and the water cooler bottle and dispenser.

16. A free standing water cooler bottle and dispenser cover comprising:
an upper housing defined by a top section, a front section, a rear section, and two side sections, wherein the dimensions of the upper housing are capable of accepting and covering a water cooler bottle;
a middle housing defined by a front section, a rear section, and two side sections, wherein the dimensions of the middle housing are capable of accepting and covering a water cooler dispenser, and wherein the middle housing includes at least one water outlet means;
a lower housing defined by a porous top section, a removable front section, a rear section, and a bottom section;
wherein the upper housing and the lower housing are detachably connected to the middle housing;
a water-resistant tray means capable of collecting water located within the lower housing and attached to the removable front section of the lower housing;
at least one of a storage and shelf means attached to the middle housing; and
a ventilation means to allow heat and moisture to escape from the air space between the top, middle, and bottom housing and a water cooler bottle and dispenser.

17. A rigid free standing water cooler bottle and dispenser cover comprising:
a housing defined by a front section, and two side sections, wherein the dimensions of the middle housing are at least capable of accepting and covering a water cooler bottle and dispenser, and wherein the housing includes at least one water outlet means, at least one of a storage and a shelf means, a plurality of retractable wheels, and a wheel engagement means.

18. The apparatus of claim 17, wherein the housing is constructed of wood.

19. The apparatus of claim 17, wherein the housing is constructed of a laminate.

20. The apparatus of claim 17, wherein the housing is constructed of molded rigid plastic.
